(19) United States
(12) Patent Application Publication
(10) Pub. No.: US 2023/0205829 A1
(43) Pub. Date: Jun. 29, 2023

(54) RECOMMENDING AND PERFORMING PERSONALIZED COMPONENT ARRANGEMENTS

(71) Applicant: Kyndryl, Inc., New York, NY (US)

(72) Inventor: Mansura Habiba, Jhonstown (IE)

(73) Assignee: Kyndryl, Inc., New York, NY (US)

(21) Appl. No.: 17/563,332

(22) Filed: Dec. 28, 2021

(51) Int. Cl. G06F 16/9535; G06F 16/9035; G06N 20/00; G06F 16/906

(52) U.S. Cl. CPC G06F 16/9535; G06F 16/906; G06F 16/9035; G06N 20/00

(57) ABSTRACT

From within a database, a first set of component arrangements corresponding to an input set of components are identified. Based on component usage data corresponding to the set of components, the first set of component arrangements is filtered, resulting in a second set of component arrangements. Component usage data is determined by classifying a component according to a usage classification. Based on context data corresponding to the set of components, the second set of component arrangements is filtered, resulting in a third set of component arrangements. Context data is determined by classifying a component according to a context classification. The third set of component arrangements is ranked according to a set of preferences output from a recommendation model. The set of components is arranged according to a ranked component arrangement in the ranked set of component arrangements.

### BACKGROUND

The present invention relates generally to a method, system, and computer program product for decorative arrangement management. More particularly, the present invention relates to a method, system, and computer program product for recommending and performing personalized component arrangements.

### SUMMARY

The present invention seeks to provide a method of training a machine learning algorithm for determining a personalized recommendation for an arrangement of components for a user. The present invention also seeks to provide a method for determining a personalized recommendation for an arrangement of components for a user. Such methods may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor. The present invention yet further seeks to provide a system for training a machine learning based recommendation model for determining a personalized recommendation for an arrangement of components for a user. The invention also seeks to provide a system for determining a personalized recommendation for an arrangement of components for a user.

The illustrative embodiments provide a method, system, and computer program product. An embodiment includes a method that identifies, from within a database, a first set of component arrangements corresponding to an input set of components, a component arrangement in the first set of component arrangements comprising an image depicting a visual arrangement of one or more components in the input set of components. An embodiment filters, based on component usage data corresponding to the set of components, the first set of component arrangements, resulting in a second set of component arrangements, wherein component usage data corresponding to a component in the set of components is determined by classifying a component according to a usage classification. An embodiment filters, based on context data corresponding to the set of components, the second set of component arrangements, resulting in a third set of component arrangements, wherein context data corresponding to a component in the set of components is determined by classifying a component according to a context classification. An embodiment ranks, according to a set of preferences output from a recommendation model, the third set of component arrangements, the ranking resulting in a ranked set of component arrangements. An embodiment arranges, according to a ranked component arrangement in the ranked set of component arrangements, the set of components.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

Embodiments may be employed in combination with conventional/existing component inventory management systems and/or user guidance systems. In this way, embodiments may integrate into legacy systems so as to improve and/or extend their functionality and capabilities. An improved recommendation system may therefore be provided by proposed embodiments.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to embodiments of the present invention.

FIG. 3 depicts abstraction model layers according to embodiments of the present invention.

FIG. 4 depicts a cloud computing note according to another embodiment of the present invention.

FIG. 5 depicts simplified diagrams of training a machine learning algorithm for recommendation determination according to an embodiment.

FIG. 6 depicts how the machine learning algorithm trained in FIG. 5 may be used for recommendation determination according to an embodiment.

FIG. 7 illustrates a method for recommendation determination according to an embodiment.

FIG. 8 illustrates a system for training a machine learning algorithm according to an embodiment.

### DETAILED DESCRIPTION

Obtaining personalized recommendations for an arrangement of components is difficult because arrangements are not uniformly pleasing to everyone, and popularity trends change often. For example, when presented with two different pictures, the only way a machine learning model can know which one looks beautiful, or which one belongs to a current trend, is through manual labelling of the images. Further, when a user looks for recommendations, current machine learning models require huge amounts of training data in order to obtain an accurate recommendation for a given individual, which is currently unviable in most applications. In the absence of personalized data, such as previously searched items or items that are liked by similar users online, a machine learning model cannot successfully determine a recommendation to be provided to a user. In addition, individual choices or preferences are often suppressed by crowd preferences in these situations.

By way of a specific example, food decoration recommendation is a particularly complex problem as the classification of ingredients and the computation of popularity of certain ingredients and decorations is often undefined. Visual resemblance is not enough to perform image classification as the context of the training images is usually absent and unaccounted for.

Indeed, in the cases of interior design, fashion trends and food decoration, the only reliable means of obtaining a recommendation for a user is through social media platform feedback-based recommendation, which is often not sufficient for meeting individual user preferences.

The illustrative embodiments recognize that the presently available tools or solutions do not address these needs or provide adequate solutions for these needs. The illustrative embodiments used to describe the invention generally address and solve the above-described problems and other problems related to recommending and performing personalized component arrangements.

An embodiment can be implemented as a software application. The application implementing an embodiment can be configured as a modification of an existing component arrangement system, as a separate application that operates in conjunction with an existing component arrangement system, a standalone application, or some combination thereof.

Particularly, some illustrative embodiments provide a method that identifies, from within a database, a first set of component arrangements corresponding to an input set of components, a component arrangement in the first set of component arrangements comprising an image depicting a visual arrangement of one or more components in the input set of components. The method filters, based on component usage data corresponding to the set of components, the first set of component arrangements, resulting in a second set of component arrangements, wherein component usage data corresponding to a component in the set of components is determined by classifying a component according to a usage classification. The method filters, based on context data corresponding to the set of components, the second set of component arrangements, resulting in a third set of component arrangements, wherein context data corresponding to a component in the set of components is determined by classifying a component according to a context classification. The method ranks, according to a set of preferences output from a recommendation model, the third set of component arrangements, the ranking resulting in a ranked set of component arrangements. The method arranges, according to a ranked component arrangement in the ranked set of component arrangements, the set of components.

One embodiment trains, to classify the component according to the usage classification, using a training set of component data corresponding to a training arrangement of components, a usage classification model. The method also trains, to classify the component according to the context classification, using a training set of context data corresponding to the training arrangement of components, a context classification model. In the embodiment, the usage classification model and the context classification model are trained in parallel.

In one embodiment, the arranging is performed according to the ranked component arrangement having a highest rank in the ranked set of component arrangements.

An embodiment updates the recommendation model responsive to a similarity measure between the first set of component arrangements and the ranked set of component arrangements. In particular, if the similarity measure is less than a first threshold, an embodiment uses the first set of component arrangements to update the recommendation model. If the similarity measure is greater than a second threshold higher than the first threshold, an embodiment uses the ranked set of component arrangements to update the recommendation model. If the similarity measure is between the first threshold and the second threshold, an embodiment uses the first set of component arrangements and the ranked set of component arrangements to update the recommendation model. In one embodiment, updating the recommendation model is performed on a batch of training data comprising a portion of a continuous input of training data including the ranked set of component arrangements.

The manner of recommending and performing personalized component arrangements described herein is unavailable in the presently available methods in the technological field of endeavor pertaining to procurement management of physical items. A method of an embodiment described herein, when implemented to execute on a device or data processing system, comprises substantial advancement of the functionality of that device or data processing system in a first set of component arrangements, filtering, based on component usage data corresponding to the set of components, the first set of component arrangements, further filtering, based on context data corresponding to the set of components, the second set of component arrangements, ranking, according to a set of preferences output from a recommendation model, the filtered set of component arrangements, and arranging, according to a ranked component arrangement in the ranked set of component arrangements, the set of components.

The illustrative embodiments are described with respect to certain types of components, component arrangements, machine learning algorithms, recommendation models, neural networks, training methods, thresholds, validations, responses, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a (processing) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Also, in the context of the present application, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server or a collection of PCs and/or servers connected via a network such as a local area network, the Internet and so on to cooperatively execute at least one embodiment of the methods of the present invention.

The technical character of the present invention generally relates to training a machine learning algorithm to generate personalized recommendations to a user, and more particularly, to determining a personalized recommendation for an arrangement of components for a user. More specifically, embodiments of the present invention provide concepts for identifying, from within a database, a first set of component arrangements corresponding to an input set of components, a component arrangement in the first set of component arrangements comprising an image depicting a visual arrangement of one or more components in the input set of components; filtering, based on component usage data corresponding to the set of components, the first set of component arrangements, resulting in a second set of component arrangements, wherein component usage data corresponding to a component in the set of components is determined by classifying a component according to a usage classification; filtering, based on context data corresponding to the set of components, the second set of component arrangements, resulting in a third set of component arrangements, wherein context data corresponding to a component in the set of components is determined by classifying a component according to a context classification; ranking, according to a set of preferences output from a recommendation model, the third set of component arrangements, the ranking resulting in a ranked set of component arrangements; and arranging, according to a ranked component arrangement in the ranked set of component arrangements, the set of components.

The invention provides a means of training a machine learning algorithm to provide a personalized recommendation to a user based on their individual preferences and the components available to them. In particular, the invention provides a means of training a machine learning algorithm to provide a personalized recommendation to a user for aesthetic arrangements of components.

Put another way, the invention provides a means of training a machine learning algorithm to generate an aesthetic arrangement of components according to a preference of the user. Thus, there may be provided a means of training a machine learning algorithm to understand a visual preference of a user and determine an arrangement of available components accordingly.

In other words, there may be provided a machine learning algorithm for assessing the components in the user’s possession and generating an arrangement for said components according to the user’s preference or taste.

In an embodiment, the method further comprises: receiving a training set of images, wherein each image depicts an arrangement of components; a training set of component data relating to the components used in the depicted arrangements; a training set of context data relating to a context of the depicted arrangements; and a training set of user preferences of the depicted arrangements. Training the machine learning algorithm is further based on the training set of component data, the training set of context data and the training set of user preferences as a training input for the machine learning algorithm.

In this way, the amount of training data available to the machine learning algorithm may be increased, thereby improving the recommendations generated by the machine learning algorithm.

In a further embodiment, the training comprises: training a first machine learning algorithm based on the training set of component data; training a second machine learning algorithm based on the training set of context data; and wherein the first machine learning algorithm is adapted to operate on incoming component data in parallel to the second machine learning algorithm operating on incoming context data. In this way, complex training data may be broken down into simpler components for training multiple trainers, which may then train a parent trainer to handle the complex incoming data.

In an embodiment, the method further comprises: controlling a permission for training data passing through a control gate of the machine learning algorithm based on a comparison between the training data and the context data and/or user preferences. In this way, the training data used to train the machine learning algorithm may be controlled to improve the training of the algorithm.

In an embodiment, controlling the permission for the training data comprises: comparing the training data to the context data and/or user preferences; calculating a similarity index based on the comparison; if the similarity index is lower than a minimum threshold value, rejecting the training data; if the similarity index is greater than a maximum threshold value, rejecting the training data; and if the similarity index is between, or equal to, the minimum threshold value and the maximum threshold value, accepting the training data. In this way, training data that is irrelevant, or overly matched to the user, may be disregarded in training the machine learning algorithm, thereby improving the training of the algorithm.

In an embodiment, the method further comprises: receiving: a training description of arrangements of components; a training set of component descriptions describing the components used in the described arrangements; a training set of contextual descriptions relating to a context of the described arrangements; and a training set of user preferences of the depicted arrangements. Training the machine learning algorithm is further based on the training set of component descriptions, the training set of context descriptions and the training set of user preferences as a training input for the machine learning algorithm.

In this way, the machine learning algorithm may be trained using text-based descriptions of arrangements of components in addition to, or instead of, images.

In an embodiment, the component data comprises data relating to one or more of: food ingredients; clothing items; and decorative items.

Embodiments of the present invention further provide concepts for a method for determining a personalized recommendation for an arrangement of components for a user, the method comprising: obtaining a set of ranked arrangements of components, which are ranked based on component data relating to the components in the arrangements, context data relating to the context of the arrangements and a measure of user preference of the arrangements; and determining a personalized recommendation for the arrangement of components based on the ranked set of arrangements of components.

In an embodiment, obtaining the set of ranked arrangements of components comprises: obtaining a plurality of images, wherein each image depicts an arrangement of components; and for each of the plurality of images: extracting component data relating to the components used in the depicted arrangement; extracting context data relating to a context of the depicted arrangement; and obtaining a measure of user preference of the depicted arrangement; generating a set of ranked arrangements of the components based on the component data, the context data and the measure of user preference.

In an embodiment, extracting component data from the plurality of images comprises one or more of: extracting an image annotation from each image; and extracting image metadata from each image. In this way, annotations and metadata from each image may be taken into account when generating the set of ranked arrangements of the components.

In an embodiment, extracting context data from the plurality of images comprises one or more of: identifying a type of arrangement depicted in each image; determining a purpose of a component within the arrangement of components; and identifying a user responsible for generating a depicted arrangement of components. In this way, the context of each image, such as the type of arrangement being depicted or the creator of a given arrangement, may be taken into account when generating the set of ranked arrangements of the components.

In an embodiment, obtaining the measure of user preference comprises one or more of: obtaining user feedback on each image; obtaining a number of interactions from the user with each image; obtaining a number of interactions from other users with each image; and obtaining a measure of the popularity of each image. In this way, the popularity and trends associated with an image may be taken into account when generating the set of ranked arrangements of the components.

In an embodiment, the number of interactions from the user with each image and/or the number of interactions from other users with each image are obtained from a social media platform.

In an embodiment, the method further comprises: generating a weighting based the measure of user preference; and applying the weighting to the context data.

In an embodiment, obtaining the set of ranked arrangements of components comprises: obtaining a description of a plurality of arrangements of components; and for each described arrangement of components: extracting component descriptions describing the components used in the described arrangement; extracting context descriptions describing a context of the described arrangement; and obtaining a measure of user preference of the described arrangement; generating a set of ranked arrangements of the components based on the component descriptions, the context descriptions and the measure of user preference.

Embodiments of the present invention further provide concepts for a computer program product for training a machine learning algorithm for determining a personalized recommendation for an arrangement of components for a user, the computer program product comprising a computer readable storage medium having program instructions embodied therewith, the program instructions executable by a processing unit to cause the processing unit to perform a method comprising: receiving: i) a ranked training set of arrangements of components, which are ranked based on component data relating to the components in the arrangements, context data relating to the context of the arrangements and a measure of user preference of the arrangements; and ii) a training recommendation for arranging the components; and training the machine learning algorithm based on the ranked training set of arrangements of components as a training input for the machine learning algorithm and the training recommendation for arranging the components as the training output for the machine learning algorithm.

Embodiments of the present invention further provide concepts for a computer program product for determining a personalized recommendation for an arrangement of components for a user, the computer program product comprising a computer readable storage medium having program instructions embodied therewith, the program instructions executable by a processing unit to cause the processing unit to perform a method comprising: obtaining a set of ranked arrangements of components, which are ranked based on component data relating to the components in the arrangements, context data relating to the context of the arrangements and a measure of user preference of the arrangements; and determining a personalized recommendation for the arrangement of components based on the ranked set of arrangements of components.

Embodiments of the present invention further provide concepts for a processing system comprising at least one processor and the computer program product described above, wherein the at least one processor is adapted to execute the computer program code of said computer program product.

Embodiments of the present invention further provide concepts for a system for training a machine learning algorithm for determining a personalized recommendation for an arrangement of components for a user, the system comprising: a processor arrangement configured to perform the steps of: receiving: i) a ranked training set of arrangements of components, which are ranked based on component data relating to the components in the arrangements, context data relating to the context of the arrangements and a measure of user preference of the arrangements; and ii) a training recommendation for arranging the components; and training the machine learning algorithm based on the ranked training set of arrangements of components as a training input for the machine learning algorithm and the training recommendation for arranging the components as the training output for the machine learning algorithm.

Embodiments of the present invention further provide concepts for a system for determining a personalized recommendation for an arrangement of components for a user, the system comprising: a processor arrangement configured to perform the steps of: obtaining a set of ranked arrangements of components, which are ranked based on component data relating to the components in the arrangements, context data relating to the context of the arrangements and a measure of user preference of the arrangements; and determining a personalized recommendation for the arrangement of components based on the ranked set of arrangements of components.

It is understood in advance that although this disclosure includes a detailed description on cloud computing, implementation of the techniques recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

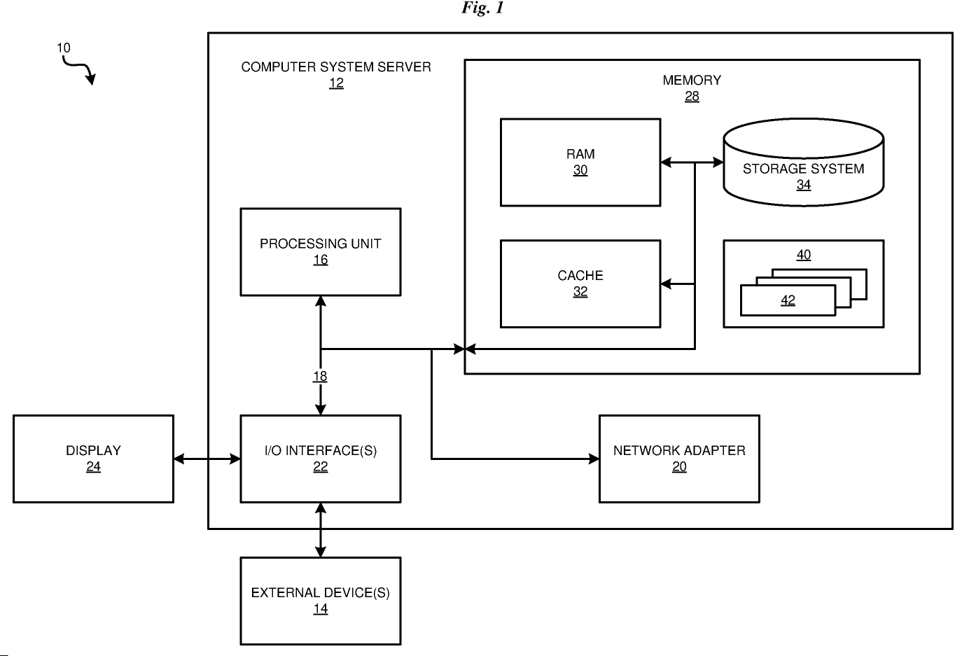

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client 80 can be implemented as one or more of the program modules 42. Additionally, the DHCP client 80 may be implemented as separate dedicated processors or a single or several processors to provide the functionality described herein. In embodiments, the DHCP client 80 performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID (redundant array of inexpensive disks or redundant array of independent disks) systems, tape drives, and data archival storage systems, etc.

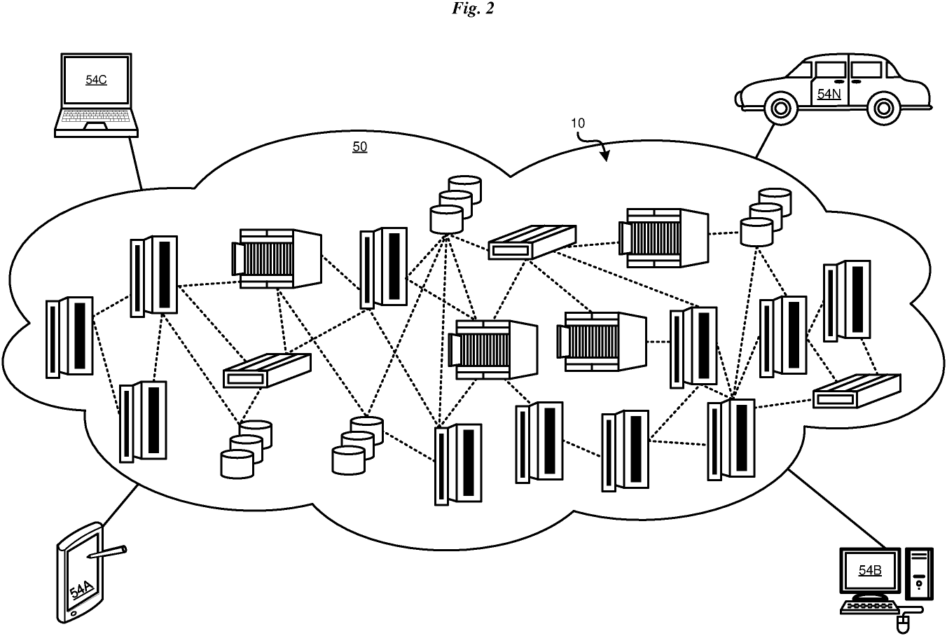

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

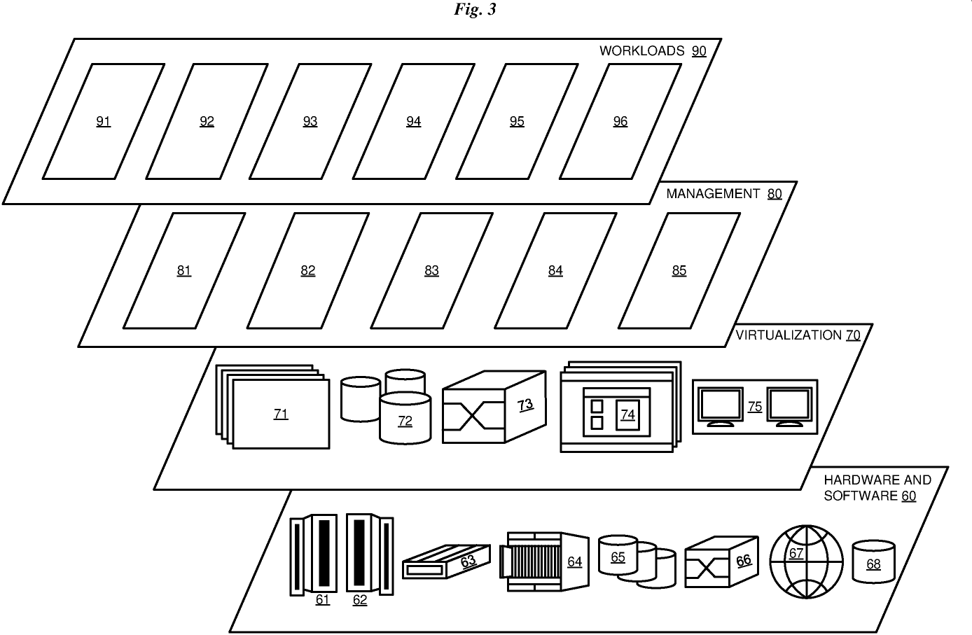

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage device 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recommendation determination processes 96 described herein. In accordance with aspects of the invention, the recommendation determination processes 96 workload/function operates to perform one or more of the processes described herein.

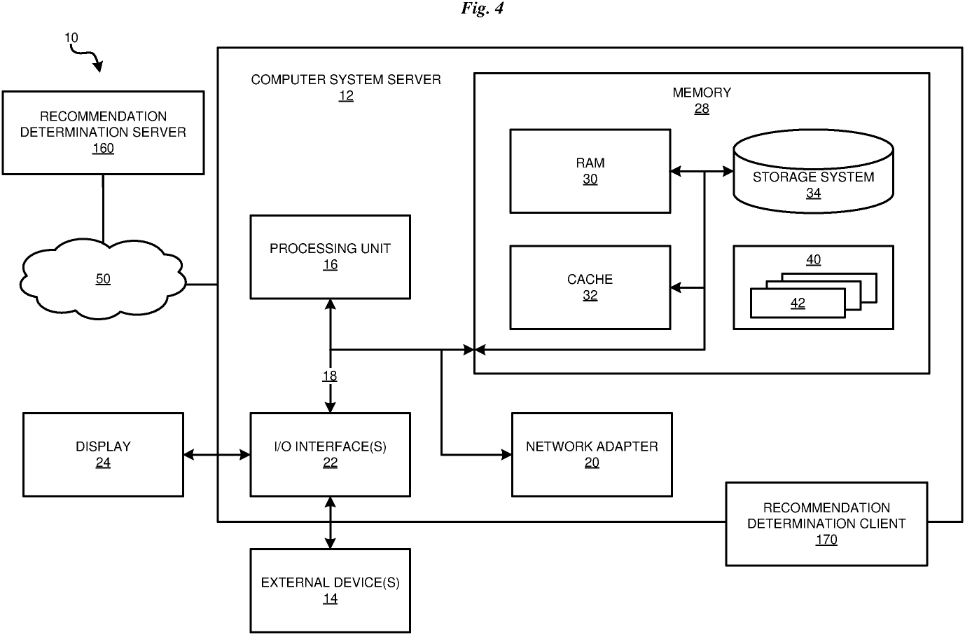

FIG. 4 depicts a cloud computing node according to another embodiment of the present invention. In particular, FIG. 4 is another cloud computing node which comprises a same cloud computing node 10 as FIG. 1. In FIG. 4, the computer system/server 12 also comprises or communicates with a recommendation determination client 170, and a recommendation determination server 160.

In accordance with aspects of the invention, the recommendation determination client 170 can be implemented as one or more program code in program modules 42 stored in memory as separate or combined modules. Additionally, the recommendation determination client 170 may be implemented as separate dedicated processors or a single or several processors to provide the function of these tools. While executing the computer program code, the processing unit 16 can read and/or write data to/from memory, storage system, and/or I/O interface 22. The program code executes the processes of the invention.

By way of example, recommendation determination client 170 may be configured to communicate with the recommendation determination server 160 via a cloud computing environment 50. As discussed with reference to FIG. 2, for example, cloud computing environment 50 may be the Internet, a local area network, a wide area network, and/or a wireless network. In embodiments of the proposed recommendation determination mechanism, the recommendation determination server 160 may provision data to the client 170. One of ordinary skill in the art would understand that the recommendation determination client 170 and recommendation determination server 160 may communicate directly. Alternatively, a relay agent may be used as an intermediary to relay messages between recommendation determination client 170 and recommendation determination server 160 via the cloud computing environment 50.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

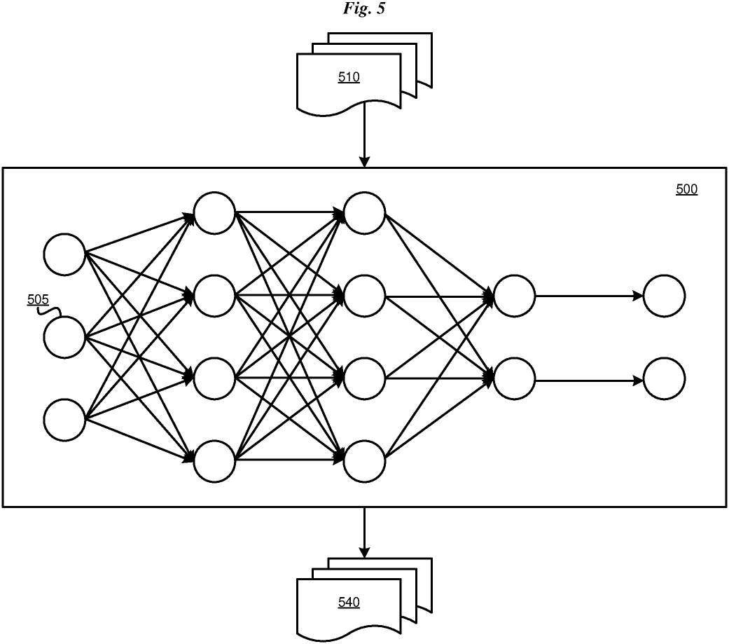

FIG. 5 illustrates an example of training a machine learning algorithm for determining a personalized recommendation for an arrangement of components for a user according to an embodiment. The example embodiment of FIG. 5 may be implemented in the environment of FIGS. 1 and 4, for example. As noted above, the flowchart(s) illustrate the architecture, functionality, and operation of possible implementations of systems, methods, and computer program products as already described herein in accordance with the various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring to FIG. 5, there is depicted simplified diagram of training a machine learning algorithm according to an embodiment. Here, the machine-learning algorithm employs an artificial neural network 500.

The structure of an artificial neural network (or, simply, neural network) is inspired by the human brain. Neural networks are comprised of layers, each layer comprising a plurality of neurons 505. Each neuron comprises a mathematical operation. In particular, each neuron may comprise a different weighted combination of a single type of transformation (e.g. the same type of transformation, sigmoid etc. but with different weightings). In the process of processing input data, the mathematical operation of each neuron is performed on the input data to produce a numerical output, and the outputs of each layer in the neural network are fed into the next layer sequentially. The final layer provides the output.

There are several types of neural network, such as convolutional neural networks (CNNs) and recurrent neural networks (RNNs). Embodiments of the present invention employ a CNN-based learning algorithm, purely by way of example. CNNs typically contain several layers, including a convolutional layer, a pooling layer, a fully connected layer and a softmax layer. The convolutional layer consists of a set of learnable filters and extracts features from the input. The pooling layer is a form of non-linear down-sampling, reducing the data size by combining the outputs of a plurality of neurons in one layer into a single neuron in the next layer. The fully connected layer connects each neuron in one layer to all the neurons in the next layer. The softmax layer determines a probability distribution for each output.

Various approaches to training a machine-learning algorithm are known. Typically, such methods comprise obtaining a training dataset, comprising training input data entries 510 and corresponding training output data entries 540. An initialized machine-learning algorithm is applied to each input data entry 510 to generate predicted output data entries. An error between the predicted output data entries and corresponding training output data entries is used to modify the machine-learning algorithm. This process can be repeated until the error converges, and the predicted output data entries are sufficiently similar (e.g. ±1%) to the training output data entries. This is commonly known as a supervised learning technique.

For example, weightings of the mathematical operation of each neuron 505 may be modified until the error converges. Known methods of modifying a neural network include gradient descent, backpropagation algorithms and so on.

The training input data entries for the proposed machine learning algorithm corresponds to a ranked training set of arrangements of components, which are ranked based on component data relating to the components in the arrangements, context data relating to the context of the arrangements and a measure of user preference of the arrangements. By way of example, the ranked training set of arrangements of components may comprise a plurality of images depicting arrangements of components that have been ranked according to component data, context data and a measure of user preference. The component data may comprise one or more of: an image annotation; image metadata; food ingredients; clothing items; decorative items and the like. The context data may comprise one or more of: an identified type of arrangement depicted in each image; a determined purpose of a component within the arrangement of components; and an identified user responsible for generating a depicted arrangement of components. The measure of user preference may comprise one or more of: user feedback on each image; a number of interactions from the user with each image, for example obtained from a social media platform; a number of interactions from other users with each image, for example obtained from a social media platform; and a measure of the popularity of each image.

The training output data entries for the proposed machine learning algorithm correspond to a training recommendation for arranging the components.

Several pre-processing methods may be employed to improve the training sample. For instance, the data sources to be used as a dataset to train the proposed machine learning algorithm may have differentiating formats. Therefore, some pre-processing may be executed to bring all training data to a common format. For this, a data pre-processor component may be used, and all data that is used to train the machine learning algorithm model may be passed through the pre-processor to achieve a consistent format of the training data.

The data format may be designed to preserve the relationship(s) between: (i) a set of components (or sets of components); and (ii) a recommended arrangement of components. In a simple form, the data may be represented as tuples of a set(s) of components and a recommended arrangement - (components1, recommended_arrangmentA), ([components2, components3], recommended_arrangementB), etc.

The training data could either come from an initial data set (e.g. training data), or from data incoming from a deployment of the present invention in a user interaction system. The initial data set may be split into a training and test data set, to provide validation for the training process.

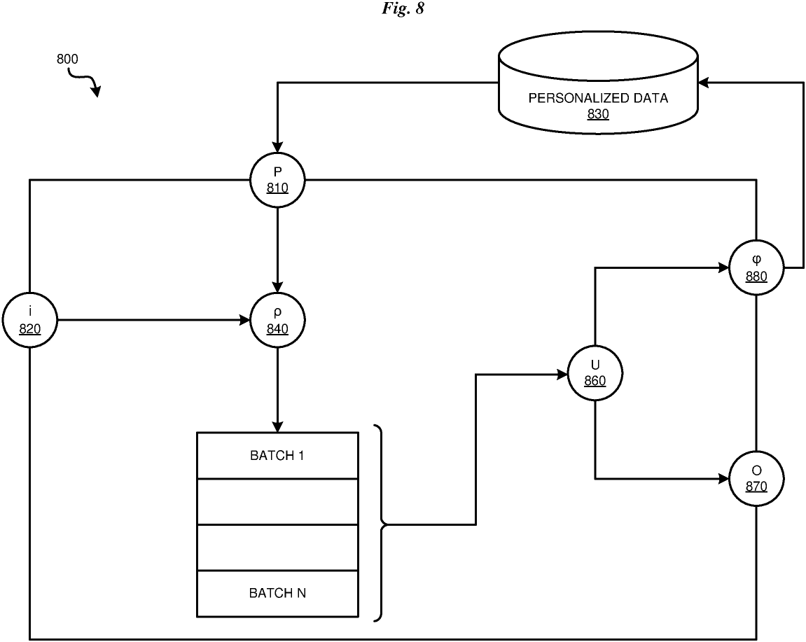

The pre-processing of input data may include one or more filtering steps in order to ensure that the training data used to train the machine learning algorithm is relevant to the application of the machine learning algorithm. An example of one such filtering step may include controlling a permission for training data passing through a control gate of the machine learning algorithm based on a comparison between the training data and the context data and/or user preference. Controlling the permission for the training data may include comparing the training data to the context data and/or user preferences and calculating a similarity index based on the comparison. If the similarity index is lower than a minimum threshold value, the training data may be rejected and if the similarity index is greater than a maximum threshold value, the training data may also be rejected. However, if the similarity index is between, or equal to, the minimum threshold value and the maximum threshold value, the training data may be accepted and used to train the machine learning algorithm. These concepts are discussed in further detail below with reference to FIG. 8.

From the above description, it will be understood that embodiment propose training a machine learning algorithm based on a ranked training set of arrangements of components, context data relating to the context of the arrangements and a measure of user preference of the arrangements (as a training input for the machine learning algorithm) and the training recommendation for arranging the components (as a training output for the machine learning algorithm). The training comprises adjusting a configuration of the machine learning algorithm so as to decrease a difference between the training set of arrangements of components and the recommendation for arranging the components that is output by the machine learning component.

In a further example, the training input data entries for the proposed machine learning algorithm may further correspond to one or more of: a training set of images, wherein each image depicts an arrangement of components; a training set of component data relating to the components used in the depicted arrangements; a training set of context data relating to a context of the depicted arrangements; and a training set of user preferences of the depicted arrangements. Accordingly, training the machine learning algorithm may be further based on the training set of component data, the training set of context data and the training set of user preferences as a training input for the machine learning algorithm.

The training input data described above may be used to train a single machine learning algorithm to determine a recommended arrangement of components based on the input data relating to a set of components available to the user. Alternatively, or in addition, the training data above may be grouped and used to train a plurality of machine learning algorithms. In particular, a first machine learning algorithm may be trained based on the training set of component data and a second machine learning algorithm may be trained based on the training set of context data. In this case, the first machine learning algorithm may be adapted to operate on incoming component data in parallel to the second machine learning algorithm operating on incoming context data.

In a yet further example, the training input data entries for the proposed machine learning algorithm may further correspond to one or more of: a training description of arrangements of components; a training set of component descriptions describing the components used in the described arrangements; a training set of contextual descriptions relating to a context of the described arrangements; and a training set of user preferences of the depicted arrangements. Accordingly, training the machine learning algorithm may be further based on the training set of component descriptions, the training set of context descriptions and the training set of user preferences as a training input for the machine learning algorithm.

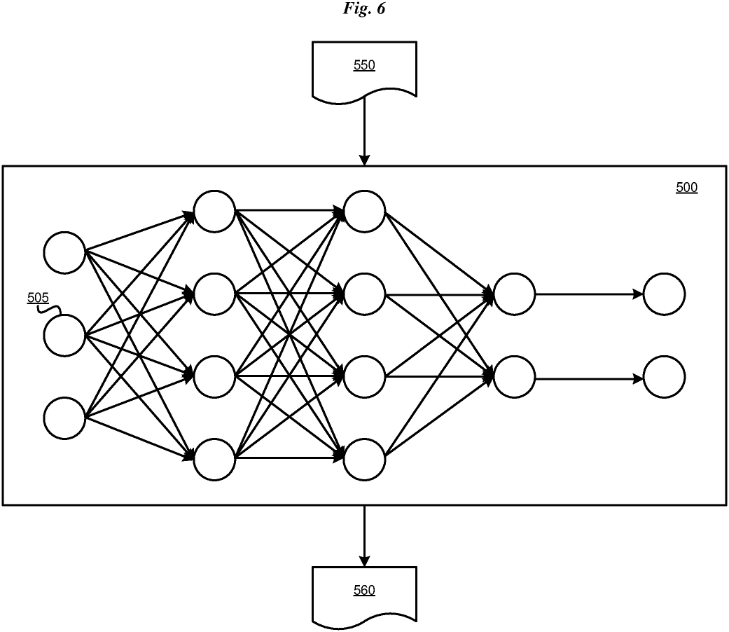

FIG. 6 is a simplified illustration depicting how the machine learning algorithm trained in FIG. 5 may be used for recommendation determination according to a proposed embodiment.

When a new set of components belonging to the user is obtained a description, or image, 550 of the new set of components may be provided as an input to the artificial neural network 500, A prediction result 560 may then be obtained as an output from the artificial neural network 500, wherein the prediction result 560 includes a recommended arrangement of the set of components predicted to be pleasing to the user. A description of, or a guide to achieving, the recommended arrangement of components may then be generated and provided to the user.

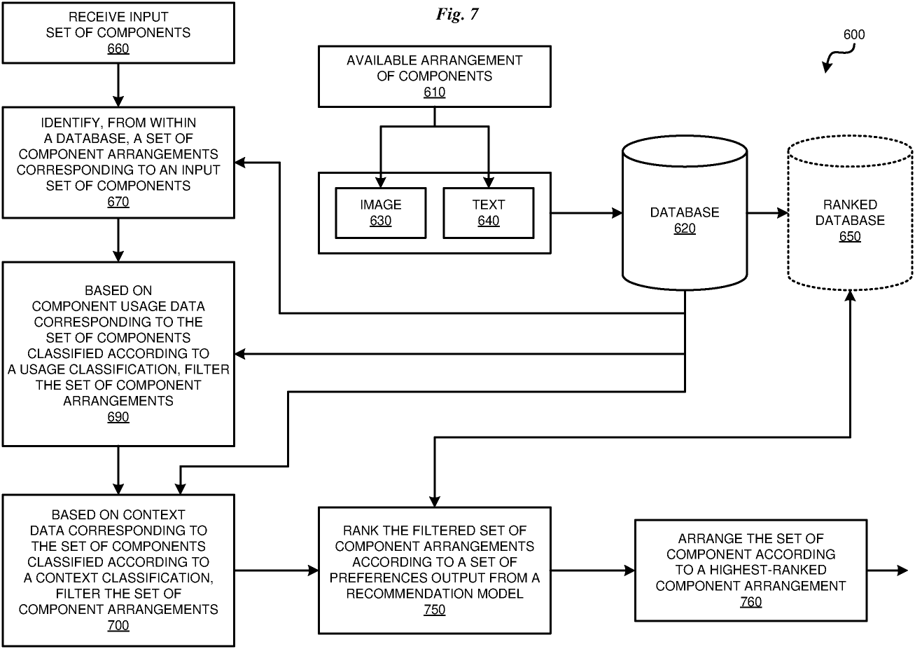

FIG. 7 illustrates a method 600 for determining a personalized recommendation for an arrangement of components for a user according to an embodiment. The example embodiment of FIG. 7 may be implemented in the environment of FIGS. 1 and 4, for example.

The method 600 for determining a personalized recommendation for an arrangement of components for a user can be described in three sections, or layers, which are data collection, data pre-processing and contextual data training. The data collection section relates to the building of a database of arrangements of components and the data pre-processing section relates to the processing of the data in the database to obtain arrangements relevant to the user. The contextual training section is described in detail herein with reference to FIG. 8. In one non-limiting example, the personalized recommendation relates to a recommended food decoration to be achieved through an arrangement of ingredients; however, it should be noted that the methods described herein may apply to any field where a personalized recommendation may be provided to a user, such as interior decoration, fashion, retail display arrangements and the like. In addition, one embodiment arranges a set of components according to a personalized recommendation of a component arrangement. For example, an embodiment configured to perform cake decoration might use a set of automated dispensers to arrange a set of cake decoration components, such as fruits, nuts, sprinkles, and icing, on the cake.

The method 600 may begin in step 610 where available arrangements of components are acquired for building a database 620 of arrangements, which may form the basis of the input data to the machine learning algorithms described above. In the case of food decoration, the available arrangements of components may include a publically available recipe and the arrangements of components may be collected from sample images depicting food decoration by a renowned chef using an application program interface (API) or cloud services.

The acquired arrangements of components may be parsed into an image component 630 and a textual component 640. For example, in the case where the acquired arrangement is a publically available recipe, the image component may include a plurality of images, wherein each image depicts an arrangement of components, or ingredients, to illustrate steps of the recipe and/or the finished meal. Further, the textual component may include the written aspect of the recipe, which may describe the ingredients being used in the recipe and depicted in the images. In addition, the textual component may further include one or more of: image captions; image metadata; image labels; an author of the recipe; a name of an ingredient; a name of a meal to be prepared by way of the recipe; and the like.

Put another way, component data, or component descriptions, and context data, or context descriptions, may be extracted from the acquired arrangements. For example, component data, relating to the ingredients used in the recipe, may be extracted from the textual component by identifying ingredient names or from the image component by performing image recognition to identify a depicted ingredient. By way of example, extracting component data from the acquired arrangements may comprise extracting an image annotation from each image and/or extracting image metadata from each image.

Further, the context data, relating to the context of the arrangement of components, may be extracted from the textual component by identifying a recipe name or meal type (such as breakfast, lunch or dinner) or from the image component by performing image recognition to identify a meal type. By way of example, extracting context data from the plurality of images may comprise one or more of: identifying a type of arrangement depicted in each image; determining a purpose of a component within the arrangement of components; and identifying a user responsible for generating a depicted arrangement of components

The image component 630 and the textual component 640 may then be stored in the database 620 for future reference. In addition, a measure of user preference associated with the acquired arrangements of components may be acquired and used to form a ranked database 650 of the arrangements for future reference. Obtaining the measure of user preference may comprise one or more of: obtaining user feedback on each image depicting a particular arrangement; obtaining a number of interactions from the user with each image depicting a particular arrangement; obtaining a number of interactions from other users with each image depicting a particular arrangement, wherein the number of interactions from the user with each image and/or the number of interactions from other users with each image may be obtained from a social media platform; and obtaining a measure of the popularity of each image depicting a particular arrangement. By way of example, if a recipe is available from a site that the user has visited many time, the measure of user preference for said recipe, or arrangement, may be high due to the large number of interactions from the user. In a further example, if a recipe is available on a social media platform and has a large number of positive interactions, either from the user or from other users, the measure of user preference for said recipe, or arrangement, may also be high.

Put another way, the measure of user preference may be used in conjunction with the extracted component and context data to generate a set of ranked arrangements of the components in the ranked database 650. By way of example, a weighting may be generated based on the measure of user preference and applied to the context data of the given arrangement. Thus, it is possible to prepare a dataset that reflects current trends and influential contextual information. For example, for food decoration data, the ranked dataset may reflect which ingredients and decorations are most popular at any given time.

In a specific example, the dataset, denoted as D, may comprise a representation of each of plurality of arrangements, denoted as d, as follows:
D={d1, d2, ..., dn}, wherein:
d={img, C, tex_recipe},
wherein: img is an image of the arrangement; C is contextual data relating to the arrangement; and tex_recipe is a textual component of the recipe. The dataset may then be ranked, or sorted, according to the measure of user preference, or the associated weighting, of each arrangement.

Accordingly, the methods of the invention provide a means of obtaining a set of ranked arrangements of components, which are ranked based on component data relating to the components in the arrangements, context data relating to the context of the arrangements and a measure of user preference of the arrangements. The set of ranked arrangements of components may then be used to determine a personalized recommendation for the arrangement of components based on the ranked set of arrangements of components as described further below.

Returning to FIG. 7, at step 660, the method receives an input set of components, for example a new set of ingredients. An input set of components includes component data and context data of the input set of components. For example, the user may specify that they currently possess rice, chicken and broccoli, which may form the component data, and that they are intending to make lunch, which may form the context data. The component data and the context data may be used to classify a decoration recipe intended by the user, for example by way of a machine learning algorithm as described herein.

In step 670, the method identifies, from within database 620, a first set of component arrangements corresponding to the input set of components. A component arrangement in the first set of component arrangements comprises an image depicting a visual arrangement of one or more components in the input set of components. For example, all recipes contained in the database that make use of rice, chicken and broccoli may be obtained from the database and put into a list. In other words, the classification of the decoration recipe may be used to search the databased to find a set of decoration recipes based on the input ingredients. A machine learning algorithm may be utilized for performing the classification of the components, or ingredients, of the arrangements from the database.

In step 690, the method filters, based on component usage data corresponding to the set of components, the first set of component arrangements, resulting in a second set of component arrangements. Component usage data corresponding to a component in the set of components is determined by classifying a component according to a usage classification. A usage classification of an ingredient, e.g., how a particular ingredient is used in the recipe, may be used to narrow down the list of arrangements in order to arrive at a more accurate arrangement recommendation for the user. For example, if a tomato is being used as an ingredient, it can be used raw, cooked, for decoration, or as part of a sauce. The usage of the ingredients may be obtained by way of a natural language algorithm, to analyse the textual component to find similar ways of using individual ingredients, or by way of computer vision image processing, which may be used to identify the usage of individual ingredients from the image component.

In step 700, the method filters, based on context data corresponding to the set of components, the second set of component arrangements into a third set of component arrangements. Context data corresponding to a component in the set of components is determined by classifying a component according to a context classification. Continuing the example, if the context of the new set of ingredients is lunch, then arrangements having the same or similar contexts, such as lunch or brunch, may be used to form the third set of arrangements. In other words, the context of how the components are going to be used may be used to further narrow down the list of arrangements in order to arrive at a more accurate arrangement recommendation for the user. A machine learning algorithm may be utilized for performing the classification of the context of the arrangements obtained from the database.

In step 750, the method ranks the third set of component arrangements according to a set of preferences output from a recommendation model and stored in ranked database 650, which have been ranked according to the preference of the user. However, if the user is a first-time user, a global user preference metric associated with the arrangements may be used as reference weighting. A user may then be provided with one or more of the ranked component arrangements according to the user’s personal preference, the available components, and the context in which the components are to be used. In one implementation of method 600, the user is provided with the highest-ranked component arrangement.

In step 760, the method arranges the set of components, according to a ranked component arrangement. In one implementation of method 600, the method arranges the set of components according to the highest-ranked component arrangement. Then the method ends.

FIG. 8 depicts a simplified illustration of a system 800 for performing contextual data training for a machine learning based recommendation model according to an aspect of the invention. The depicted system includes a preference gate 810 and an input gate 820.

In practice, training data is fed continuously through the input gate 820 and, at the same time, predefined personalized data, or context aware data, stored in a database 830 is fed to the system through a preference gate, or context aware data input gate.

The training data and the personalized data may then be fed to a control gate 840, which is introduced in the system to control the incoming data from both the input gate 820 and the preference gate 810. The control gate may be adapted to control the stream of incoming data to prevent irrelevant data from being used in the training of the machine learning algorithm but also to prevent over-fitting.

The control gate may be adapted to calculate a similarity index between the training data, a set of component arrangements, and the preference data, a set of component arrangements ranked according to a user preference. If the similarity index is less than a threshold value for a minimum similarity between the training data and the preference data, the input gate 820 may be closed to prevent irrelevant incoming training data. If the similarity index is greater than a threshold value for a maximum similarity between the training data and the preference data 810, the preference gate may be closed in order to prevent the over-fitting or over-influence of the personalized data.

Once the data has passed the control gate 840, i.e. the data having a similarity index between the minimum and maximum thresholds, intermediate training is performed in batches by way of a batch trainer. The trained data is then passed to an update gate 860, which passes the data to an output gate 870 as well as an update preference gate 880. Data that is output on the update preference gate 880 may be used to update the context aware database 830, .

As the training process described above with reference to FIG. 8 controls the incoming data to remove irrelevant data for training, very little data needs to be trained in order to acquire a successful arrangement recommendation. As the proposed system controls the train of raw data based on a similarity index with respect to a context aware dataset, the trained model, or machine learning algorithm, may better reflect the preferences of an individual user.

In some applications of the invention, the datasets can be complex and additional classification based training may be required before personalized recommendations can be attained, such as, for a food recipe decoration recommendation where along with recommendations for similar ingredients it is also necessary to provide recommendations of decoration style. For such complex datasets, training data may be fed into a trainer that includes multiple class-based trainers. For example, a parent trainer may be connected to two separate trainers, which trains the data in parallel for each batch of input data and send back the trained data output to the parent trainer. In this way, the incoming data may be processed in multiple way in order to address different parameters to be considered by the parent trainer. Such a parallel training technique does not increase processing times as each of trainer is running in parallel.

It should now be understood by those of skill in the art, in embodiments of the present invention, the proposed machine-learning concepts provide numerous advantages over conventional recommendation determination approaches. These advantages include, but are not limited to, efficient and accurate identification of a recommendation for arranging a plurality of components. In embodiments of the present invention, this technical solution is accomplished by training/employing a machine learning algorithm/model.

In still further advantages to a technical problem, the systems and processes described herein provide a computer-implemented method for efficient recommendation determinations at edge computing environments, and the recommendations may be provided on (or via) on a distributed communication network. In this case, a computer infrastructure, such as the computer system shown in FIGS. 1 and 4 or the cloud environment shown in FIG. 2 can be provided and one or more systems for performing the processes of the invention can be obtained (e.g., created, purchased, used, modified, etc.) and deployed to the computer infrastructure. To this extent, the deployment of a system can comprise one or more of:
(i) installing program code on a computing device, such as computer system shown in FIG. 1, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ± 8% or 6%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client’s operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

1. A computer-implemented method comprising:
identifying, from within a database, a first set of component arrangements corresponding to a set of components, a component arrangement in the first set of component arrangements comprising an image depicting a visual arrangement of one or more components in the set of components;
filtering, based on component usage data corresponding to the set of components, the first set of component arrangements, resulting in a second set of component arrangements, wherein component usage data corresponding to a component in the set of components is determined by classifying a component according to a usage classification;
filtering, based on context data corresponding to the set of components, the second set of component arrangements, resulting in a third set of component arrangements, wherein context data corresponding to a component in the set of components is determined by classifying a component according to a context classification;
ranking, according to a set of preferences output from a recommendation model, the third set of component arrangements, the ranking resulting in a ranked set of component arrangements; and
arranging, according to a ranked component arrangement in the ranked set of component arrangements, the set of components.

2. The computer-implemented method of claim 1, further comprising:
training, to classify a component according to the usage classification, using a training set of component data corresponding to a training arrangement of components, a usage classification model;
training, to classify the component according to the context classification, using a training set of context data corresponding to the training arrangement of components, a context classification model; and
wherein the usage classification model and the context classification model are trained in parallel.

3. The computer-implemented method of claim 1, wherein the arranging is performed according to the ranked component arrangement having a highest rank in the ranked set of component arrangements.

4. The computer-implemented method of claim 1, further comprising:
updating, using the first set of component arrangements, responsive to a similarity measure between the first set of component arrangements and the ranked set of component arrangements being less than a first threshold, the recommendation model.

5. The computer-implemented method of claim 1, further comprising:
updating, using the first set of component arrangements and the ranked set of component arrangements, responsive to a similarity measure between the first set of component arrangements and the ranked set of component arrangements being greater than a first threshold and less than a second threshold higher than the first threshold, the recommendation model.

6. The computer-implemented method of claim 1, further comprising:
updating, using the ranked set of component arrangements, responsive to a similarity measure between the first set of component arrangements and the ranked set of component arrangements being greater than a second threshold, the recommendation model.

7. The computer-implemented method of claim 1, wherein updating the recommendation model is performed on a batch of training data, the batch comprising a portion of a continuous input of training data including the ranked set of component arrangements.

8. A computer program product for component arrangement, the computer program product comprising:
one or more computer readable storage media, and program instructions collectively stored on the one or more computer readable storage media, the stored program instructions comprising:
program instructions to identify, from within a database, a first set of component arrangements corresponding to a set of components, a component arrangement in the first set of component arrangements comprising an image depicting a visual arrangement of one or more components in the set of components;
program instructions to filter, based on component usage data corresponding to the set of components, the first set of component arrangements, resulting in a second set of component arrangements, wherein component usage data corresponding to a component in the set of components is determined by classifying a component according to a usage classification;
program instructions to filter, based on context data corresponding to the set of components, the second set of component arrangements, resulting in a third set of component arrangements, wherein context data corresponding to a component in the set of components is determined by classifying a component according to a context classification;
program instructions to rank, according to a set of preferences output from a recommendation model, the third set of component arrangements, the ranking resulting in a ranked set of component arrangements; and
program instructions to arrange, according to a ranked component arrangement in the ranked set of component arrangements, the set of components.

9. The computer program product of claim 8, the stored program instructions further comprising:
program instructions to train, to classify a component according to the usage classification, using a training set of component data corresponding to a training arrangement of components, a usage classification model;
program instructions to train, to classify the component according to the context classification, using a training set of context data corresponding to the training arrangement of components, a context classification model; and
wherein the usage classification model and the context classification model are trained in parallel.

10. The computer program product of claim 8, wherein the arranging is performed according to the ranked component arrangement having a highest rank in the ranked set of component arrangements.

11. The computer program product of claim 8, the stored program instructions further comprising:
program instructions to update, using the first set of component arrangements, responsive to a similarity measure between the first set of component arrangements and the ranked set of component arrangements being less than a first threshold, the recommendation model.

12. The computer program product of claim 8, the stored program instructions further comprising:
program instructions to update, using the first set of component arrangements and the ranked set of component arrangements, responsive to a similarity measure between the first set of component arrangements and the ranked set of component arrangements being greater than a first threshold and less than a second threshold higher than the first threshold, the recommendation model.

13. The computer program product of claim 8, the stored program instructions further comprising:
program instructions to update, using the ranked set of component arrangements, responsive to a similarity measure between the first set of component arrangements and the ranked set of component arrangements being greater than a second threshold, the recommendation model.

14. The computer program product of claim 8, wherein updating the recommendation model is performed on a batch of training data, the batch comprising a portion of a continuous input of training data including the ranked set of component arrangements.

15. The computer program product of claim 8, wherein the stored program instructions are stored in the at least one of the one or more storage media of a local data processing system, and wherein the stored program instructions are transferred over a network from a remote data processing system.

16. The computer program product of claim 8, wherein the stored program instructions are stored in the at least one of the one or more storage media of a server data processing system, and wherein the stored program instructions are downloaded over a network to a remote data processing system for use in a computer readable storage device associated with the remote data processing system.

17. A computer system comprising one or more processors, one or more computer-readable memories, and one or more computer-readable storage media, and program instructions stored on at least one of the one or more storage media for execution by at least one of the one or more processors via at least one of the one or more memories, the stored program instructions comprising:
program instructions to identify, from within a database, a first set of component arrangements corresponding to a set of components, a component arrangement in the first set of component arrangements comprising an image depicting a visual arrangement of one or more components in the set of components;
program instructions to filter, based on component usage data corresponding to the set of components, the first set of component arrangements, resulting in a second set of component arrangements, wherein component usage data corresponding to a component in the set of components is determined by classifying a component according to a usage classification;
program instructions to filter, based on context data corresponding to the set of components, the second set of component arrangements, resulting in a third set of component arrangements, wherein context data corresponding to a component in the set of components is determined by classifying a component according to a context classification;
program instructions to rank, according to a set of preferences output from a recommendation model, the third set of component arrangements, the ranking resulting in a ranked set of component arrangements; and
program instructions to arrange, according to a ranked component arrangement in the ranked set of component arrangements, the set of components.

18. The computer system of claim 17, the stored program instructions further comprising:
program instructions to train, to classify a component according to the usage classification, using a training set of component data corresponding to a training arrangement of components, a usage classification model;
program instructions to train, to classify the component according to the context classification, using a training set of context data corresponding to the training arrangement of components, a context classification model; and
wherein the usage classification model and the context classification model are trained in parallel.

19. The computer system of claim 17, wherein the arranging is performed according to the ranked component arrangement having a highest rank in the ranked set of component arrangements.

20. The computer system of claim 17, the stored program instructions further comprising:
program instructions to update, using the first set of component arrangements, responsive to a similarity measure between the first set of component arrangements and the ranked set of component arrangements being less than a first threshold, the recommendation model.
